(19) United States
(12) Patent Application Publication
(10) Pub. No.: US 2026/0132942 A1
(43) Pub. Date: May 14, 2026

(54) AIR PURIFICATION DEVICE

(71) Applicant: BOTANICAL DEVELOPMENT S.R.L., FIRENZE (FI) (IT)

(72) Inventors: Camilla PANDOLFI, Firenze, FI (IT); Antonio GIRARDI, VENEZIA (IT); Cristiana FAVRETTO, San Donà di Piave (VE) (IT); Elisa AZZARELLO, FIRENZE (IT)

(21) Appl. No.: 19/118,276

(22) PCT Filed: Oct. 3, 2023
(86) PCT No.: PCT/IB2023/059923

§ 371 Date: Apr. 3, 2025

(30) Foreign Application Priority Data
Oct. 4, 2022 (IT) 102022000020352

(51) Int. Cl. F24F 8/175; A01G 9/02; A01G 27/00

(52) U.S. Cl. CPC F24F 8/175; A01G 9/02

(57) ABSTRACT

A purification device (1) of air is provided comprising a container (2) defining a housing for a substrate (1b) for culturing one plant (1a) and comprising a panel (21) defining a wall of the housing configured to come in contact with the substrate (1b) and a separation plane (21a); the panel (21) comprises depressions (211), protrusions (212) comprising holes (212a) allowing an air flow to pass through said panel (21) and enter said housing; said holes (212a) are obtained exclusively in the protrusions (212) so that the substrate (1b) at the protrusions (212) is passed through by the air flow and at the depressions (211) is not passed through by the air flow ensuring the permanence of humidity in the substrate (1b) contained in the depressions (211) and then the definition of a biofilm which, coming in contact with said air flow, purifies the air flow.

The present invention relates to an air purification device of the type specified in the preamble of first claim.

As it has been known for many years, the plants are capable of absorbing, and partially degrading, several polluting components of air. They are capable of absorbing some volatile molecules directly from the stomata and to degrade them. Nevertheless, only in the last years the plants have been cultivated and then exploited for air purification.

In detail, in the last years air purification devices have been devised comprising a pot containing the substrate necessary for the growth of one or more plants; and a forced recirculation system generating an air flow passing through the plants and the substrate.

Examples of these systems are described in CN101451751A, WO2011115806A2 and WO2014123722.

The described known art comprises some important drawbacks.

In particular, the known air purification devices exploiting one or more plants have a low purification capability and they are capable of purifying small volumes of air. Another drawback then is represented by the fact that such low purification capability forces to implement particularly bulky devices.

These drawbacks, moreover, translate into high costs and implementation and management complexity which make the known air purification devices to be of little interest and then little exploited.

In this situation the technical task underlying the present invention is to devise an air purification device capable of substantially obviating at least partially the mentioned drawbacks.

Within said technical task an important object of the invention is to obtain an air purification device having a high purification capability and in particular which is capable of purifying huge volumes of air.

Another important object of the invention is to implement a purification device having reduced overall dimensions.

Another additional object of the present invention is to have an air purification device with reduced costs and implementation complexity.

The technical task and the specified objects are achieved by an air purification device as claimed in the enclosed claim 1. Examples of preferred embodiment are described in the depending claims.

The features and advantages of the invention are explained hereinafter in the detailed description of preferred embodiments of the invention, with reference to the enclosed drawings, wherein:

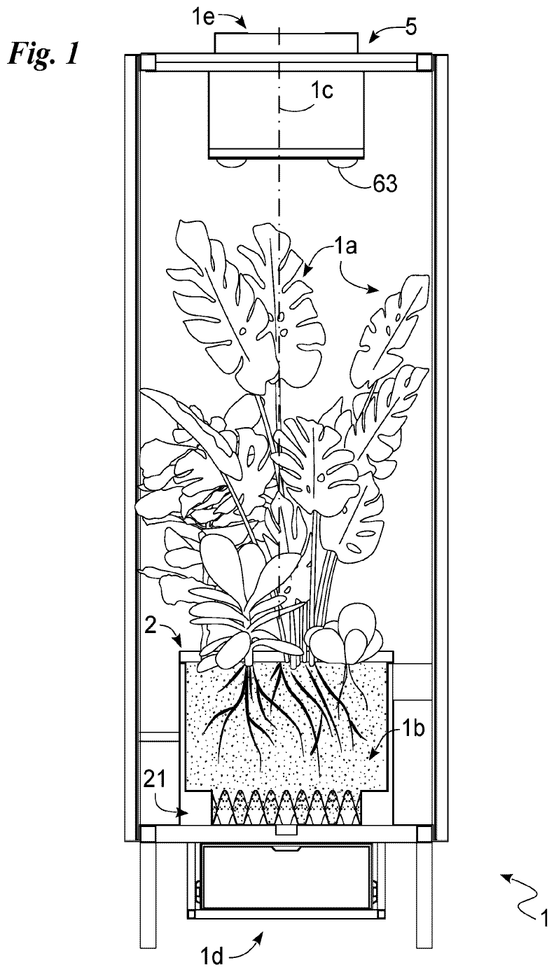

FIG. 1 shows, to scale, an air purification device according to the invention in use;

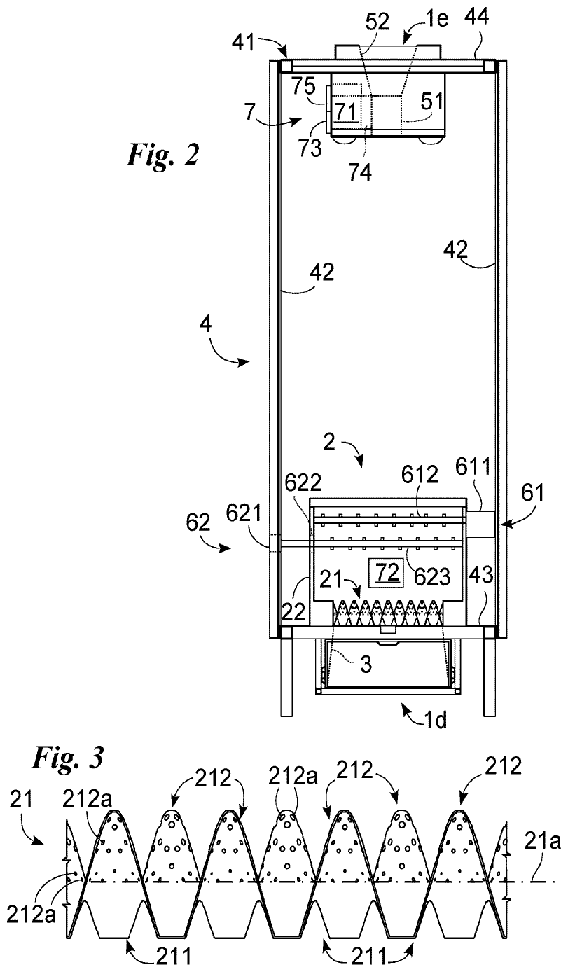

FIG. 2 illustrates, to scale, a purification device; and

FIG. 3 shows, to scale, part of a detail of the air purification device according to the invention.

In the present document, the measurements, values, shapes and geometrical references (such as perpendicularity and parallelism), when associated to words such as “about” or other similar terms such as “approximately” or “substantially”, are to be meant as excluding measurements errors or inaccuracies due to production and/or manufacturing errors and, above all, excluding a slight deviation from the value, measurement, shape or geometrical reference thereto it is associated. For example, such terms, if associated to a value, preferably designate a divergence not higher than 10% of the value itself.

Moreover, when used, terms such as “first”, “second”, “higher”, “lower”, “main” and “secondary” do not identify necessarily an order, a relation priority or relative position, but they can be simply used to distinguish more clearly components different from each other.

Unless otherwise designated, “perpendicular”, “transversal”, “parallel” or “normal” or other terms of geometric positioning between geometric elements (for example axes, directions and straight lines) are to be meant with reference to their mutual geometric position between the corresponding projections. Said projections are defined on one single plane parallel to the one(s) in which said geometric elements lie.

The measurements and data reported in the present text are to be considered, unless otherwise indicated, as performed under International Standard Atmosphere ICAO (ISO 2533:1975).

Unless otherwise specified, as it results from the following discussions, it is considered that terms such as “treatment”, “computer science”, “determination”, “calculation”, or the like, relate to the action and/or processes of a computer or similar electronic calculation device which manipulates and/or transforms data represented as physical data, such as electronic quantities of registers of a computer system and/or memories into other data similarly represented as physical quantities within computer systems, registers or other devices for storing, transmitting or displaying information.

With reference to Figures, the air purification device according to the invention is designated as a whole with number 1.

As shown in FIG. 1, it is configured to purify air by exploiting one or more plants 1a or other vegetable and in particular the substrate 1b for the growth of plants 1a. The purification device 1 can include one or more plants 1a.

The purification device 1 can include a substrate 1b for culturing at least one plant 1a.

The substrate 1b can be defined as the base or substance (in some cases a mixture) of which the one or more plants 1a require to live and grow, thereto the one or more plants 1a are fastened and therefrom they draw nourishment. The substrate 1b then meets the particular needs for the equilibrated growth of plants 1a, such as for example amount of air, water and nutrients.

The purification device 1 can define a longitudinal axis 1c suitably parallel to the gravitational gradient.

The purification device 1 can define a chamber for culturing at least one plant 1a. Preferably the culture chamber is substantially sealed except the below-mentioned inlet and outlet sections.

The at least one plant 1a and at least part of the substrate 1b can be placed in the culture chamber.

The device 1 can include an inlet section 1d allowing an air flow to access to the culture chamber and an outlet section 1e allowing to flow from the culture chamber. The inlet section 1d can be substantially transversal and in detail substantially normal to the longitudinal axis1c and in particular to the gravitational gradient.

The outlet section 1e can be on the side opposite to the inlet section 1d with respect to the chamber.

It can be almost transversal and in detail substantially normal to the longitudinal axis1c and in particular to the gravitational gradient. It can be almost parallel to the inlet section 1d.

The purification device 1, illustrated in FIG. 2, can include a container 2 for housing the substrate 1b and an opening defining the growth section of one or more plants 1a, that is the surface therefrom at least the cauline apparatus/system (that is the part protruding from the substrate and then including for example stem, branches and leaves), of the one or more plants 1a protrudes from the container 2 and then from the substrate 1b.

The air flow performs the following path: it enters the purification device 1, suitably in exclusive way, through the inlet section 1c; it reaches the housing where it suitably passes through the substrate 1b; through the opening it accesses to the culture chamber and then it outgoes from the device 1, suitably in exclusive way, from the outlet section 1d.

The container 2 can include a panel 21 defining a wall of the housing and, suitably, at least a supplementary panel 22 defining and then delimiting the housing together with the panel 21 and preferably said opening.

The at least a supplementary panel 22 can be substantially parallel to the longitudinal axis 1c.

The panel 21 (FIG. 3) is configured to come in contact with the substrate 1b and to intercept the air flow coming from the inlet section 1d before reaching the same substrate 1b. It is interposed between inlet section 1d and housing and then between inlet section 1d and substrate 1b. In this document terms and expressions such as “interposed”, “downstream” and “upstream” are to be meant with respect to the direction/sense of the path of the above-described air flow.

The panel 21 can define the bottom of the housing and then identify in use (that is when the substrate 1b is placed in the housing and the plants are in the culture chamber) the resting surface of the support 1b and then of the one or more plants 1a.

The panel 21 defines a separation plane 21a. Consequently, the panel 21 develops preferably along the separation plane 21a which is substantially barycentric.

With respect to the plane 21a, it comprises at least a depression 211 defining a collecting compartment for part of the substrate 1b; and at least a protrusion 212 at least partially and in detail substantially wholly covered by the substrate 1b.

Preferably the panel 21 comprises several depressions 211 and several protrusions 212 suitably alternated to each other. Then, it can have a profile substantially analogous to a known cardboard/container/tray for eggs.

The separation plane 21a can be barycentric.

The separation plane 21a can be substantially transversal and in detail substantially normal to the direction/sense of advancement of the air flow.

It can be substantially parallel to the outlet section 1e.

The separation plane 21a and then the panel 21 can be substantially transversal and in detail almost perpendicular to the longitudinal axis 1c.

Each depression 211 with respect to the separation plane 21a represents a hollow. It then defines a portion of panel 21 suitably protruding from the plane 211 on the side opposite to the housing and delimiting a collection housing portion of the substrate 1b.

It can have a tapered profile having preferably maximum section at the separation plane 21a.

Each depression 211 can have a substantially flat bottom.

Each protrusion 212 with respect to the separation plane 21a represents a projection. It then defines a portion of panel 21 suitably protruding from the plane 211 towards the housing.

Consequently the at least a protrusion 212 protrudes from the separation plane 21a on the side opposite to the at least a depression 211.

Each protrusion 212 can have a tapered profile having preferably maximum section at the separation plane 21a.

Each protrusion 212 can have a substantially ogive-like apex.

Preferably depressions 211 and protrusions 212 have substantially the same thickness and then the panel 21 has substantially constant thickness. Said thickness can be lower than 10 mm and in detail substantially comprised between 2 mm and 5 mm.

They can be made of plastic materials. In detail the panel 21 is in one single piece. At least one of the protrusions 212 can be perforated and then it can comprise one or more holes 212a allowing the air flow to pass through the panel 21 through said holes. In particular the holes 212a are the only section for passing the air flow from the inlet section 1d and to the housing and then to the substrate 1b.

Preferably all protrusions 212 comprise holes 212a. Alternatively, only part of the protrusions 212 can provide holes 212a.

The holes 212a can advantageously be obtained only at the protrusions 212 by leaving the depressions without holes. Therefore, the substrate 1b at the protrusions 212 is passed through by the air flow, whereas the one at (in detail inside) the depressions 211 is not passed through by such flow ensuring the permanence of humidity in the substrate 1b at (in detail inside) the depressions 211 and then the definition in said substrate 1b of a biofilm which, coming in contact with the air flow passing through the substrate 1a, purifies the same air flow.

The holes 212a are configured to allow the passage of air and prevent substrate and preferably water from passing. They have a section smaller than 100 mm² and in detail 50 mm² more in detail 10 mm² (suitably 3 mm² ) and/or a linear extension lower than 10 mm and in detail substantially comprised between 1 mm and 5 mm. The holes 212a can have any section. For example, they can be circular (as shown in Figures) or be analogous to slots.

The holes 212a can have the same section, that is they can have a section with same extension. In a preferred alternative, they have different section and in particular they have a section inversely proportional with respect to the distance from the apex of the protrusions 212.

It is highlighted that the device 1 then could include a channel 3 defining the inlet section 1d and put said section 1d in fluid passage connection with the panel 21. Said channel 3 can be an extension of one or more supplementary panels 22.

The purification device 1 can include a structure 4 defining said culture chamber containing at least part of the container 2 and in use of the substrate 1b and one or more plants 1a.

The structure 4 can include a frame 41 supporting the structure 4 and then the device 1; and one or more walls delimiting the culture chamber. In detail, the walls 41 can include one or more lateral walls 42, a lower wall 43 thereto the container 2 is anchored and an upper wall 44 placed on side opposite to the lower wall with respect to the chamber.

The lower wall 43 can define the inlet section 1d.

The upper wall 44 can define the outlet section 1e.

At least part of one or more lateral walls 42 can be made of glass or other transparent material, to allow the passage of light.

The one or more lateral walls 42 can be almost parallel to the axis 1c.

Optionally they can define an extension of the supplementary panels 22.

The purification device 1 can include a recirculation system 5 defining the air flow passing through the inlet section 1d and then the housing.

The recirculation system 5 is configured to allow the device 1 to exchange air between outside and culture chamber.

It can be forced. It can work under pressure drop and in particular by placing the culture chamber and precisely the housing at a pressure lower than the inlet section 1d suitably having pressure equal to the one outside the device and then to the atmospheric pressure.

The recirculation system 5 can include an aspirator 51 for collecting air from the culture chamber and a duct 52 placing the aspirator 51 in fluid passage connection with the outlet section 1e.

The recirculation system 5 can be integrated in the upper wall 44.

The purification device 1 can include a system 6 for the supply to one or more plants 1a required for their sustenance.

The supply system 6 can be integral to the structure 4.

The apparatus 6 can include an irrigation block 61 configured to supply water to the substrate 1b.

The irrigation block 61 can include at least one source 611 of suitably sanified water; one or more nozzles 612 for dispensing water; and a distributor 613 configured to collect water from the source 611 and to provide it to the substrate 1b through said nozzles 612.

The source 611 can include a water tank. In alternative or in addition it can include a connection to water main outside the device 1. In particular the source 611 is configured to sanify water and then it can include a sanitizer such as UV lamp.

The distributor 613 can be a known irrigation device, such as a sprinkler, nebulization, infiltration or drop irrigation device.

The supply system 6 can include a lighting block 62 configured to ensure the required light conditions to the one or more plants 1a.

The lighting block 62 can include one or more light emitters for example of full spectrum type and thus covering the electromagnetic spectrum from infrared to ultraviolet useful for one or more plants 1a.

The purification device 1 can include a system 7 for controlling the operation of the same.

The control system 7, for the sake of simplicity shown only in FIG. 2, can include a board 71 for controlling the recirculation system 5 (in detail the aspirator 51) and suitably the supply system 6.

The control system 7 can include an interface configured to allow an operator to exchange data with the board 71; and means for connecting between board and interface.

The interface can include a screen and/or a keyboard integrated in the device 1 (in detail in the structure 4). Alternatively, the interface can be an external processor (such as tablet or smartphone) and the connecting means can be wireless.

The control system 7 can include at least a humidity sensor 72 configured to detect the humidity of the substrate 1b at least at the depressions 211.

The humidity sensor 72 can be a known tensiometer.

The humidity sensor 72 can be in data connection with the board 71 which, then, controls the irrigation block 61 and/or the recirculation system 5 depending upon the humidity of the substrate 1b detected by said sensor 72.

In particular la board 71 controls the deactivation of the recirculation system 5 if the humidity of the substrate 1b is lower than a minimum humidity threshold and its activation if the humidity of the substrate 1b is at least equal to a maximum humidity threshold. In alternative or in addition the board 71 controls the activation of the irrigation block 61 if the humidity of the substrate 1b is lower than said minimum humidity threshold and the deactivation of the irrigation block 61 if the humidity of the substrate 1b is at least equal to said maximum humidity threshold.

The control system 7 can include a light sensor 73 configured to measure the lighting of one or more plants 1°.

The light sensor 73 can be in data connection with board 71 which, then, controls the irrigation block 61 depending upon the amount of the light detected by said light sensor 73. In particular the board 71 controls the activation of the irrigation block 61 if the light amount 1b is lower than a minimum light threshold.

The control system 7 can include a flow sensor 74 configured to measure the air flow passing through the substrate and then one of the sections 1d and 1e.

The flow sensor 74 can be in data connection with the board 71 which, then, controls the recirculation system 5 depending upon the entity of the flow detected by said flow sensor 74. In particular the board 71 controls the activation of the recirculation system 5 if the entity of the flow is lower than a minimum flow threshold and its deactivation if the entity of the flow is at least equal to a maximum flow threshold. The control system 7 can include a clock 75 configured to measure the passage of time.

The clock 75 can be in data connection with the board 71 which, then, controls the one or more blocks 61, 61 and/or 62 according to a preset time and of the clock 75. The operation of the previously described purification device 1 in structural terms is the following.

Once placed the substrate 1b and then the plants 1a the device is ready.

The air, attracted by pressure drop by the aspirator 51, enters through the inlet section 1d and, through the panel 21 (precisely the one or more holes 212a obtained in the protrusions 212), enters the container 2 and, precisely, it passes through the substrate. The air then outgoes from the container 2 through the opening and it is then collected and purified by the plants 1a. Once the purification is completed, the air, still pushed by the aspirator 51 of the recirculation system 5, is ejected from the device 1 through the duct 52 and then the outlet section 1e.

During operation the sensor 72, depending upon the humidity of the substrate 1b, can control the irrigation block 61 and/or the recirculation system 5 so as to have wished humidity of the substrate 1b.

Moreover, according to the programming selected by the operator, the control system 7 adjust the lighting (intensity and/or duration) and the dosage of fertilizers by the fertilizing block 61.

The purification device 1 according to the invention achieves important advantages. In fact, contrary to the known purification devices, it is capable of purifying relatively high volumes of air. Such advantage has been mainly obtained thanks to the fact that the device allows to have still the optimum growth conditions of plants 1a.

Moreover, the air purification has been advantageously obtained by making the air to pass in the substrate 1b. In fact, the holes 212a, since they are obtained only at the protrusions 212, allow to avoid an excessive drying of the substrate even with important air flows, and then to have still a biofilm which, coming in contact with the air passing through the substrate 1a, purifies said air. In detail, the substrate 1b at the protrusions 212 is passed through by the air flow, whereas the one at (in detail inside) the depressions 211 is not passed through by such flow ensuring the permanence of humidity in the substrate 1b at (in detail inside) the depressions 211 and then the definition in said substrate 1b of a biofilm which, coming in contact with the air flow passing through the substrate 1a, purifies the same air flow. Then the adoption of the new panel 21 avoids an excessive drying of the substrate even with important air flows, and then to have still a biofilm which, coming in contact with the air passing through the substrate 1a, purifies said air. Thanks thereto, the device 1 has a high purification capability and in particular it is capable of purifying huge volumes of air.

Another advantage is represented by the fact that the purification device 1 allows to purify huge amounts of air, while having reduced overall dimensions.

A not secondary advantage is then represented by the fact that the purification device 1 has reduced implementation and management costs and it results to be simple to be implemented and especially to be managed thanks to the board 71 and to the several sensors 72, 73 and 74 allowing to monitor and then to adjust all parameters of the device 1.

The invention is subject to variations within the inventive concept defined by the claims.

For example, the panel 21 can include several modules, each one defining a panel portion; and constraining means configured to constrain, preferably integrally, said modules to each other.

Each module can include at least said depression and at least said protrusion 212 suitably providing one or more of the above-described holes 212.

Within such scope, all details can be replaced by equivalent elements and the materials, shapes and sizes can be any.

1. Air purification device (1) comprising
a container (2) defining a housing for a substrate (1b) for culturing at least one plant (1a); characterised by said container (2) comprises
a panel (21) defining a wall of said housing configured to contact said substrate (1b) and a separation plane (21a);
by that said panel (21) comprises with respect to said separation plane (21a)
depressions (211) each defining a collecting compartment for part of said substrate (1b);
protrusions (212) configured to be at least partially covered by said substrate (1b); and by said projections (212) comprise
holes (212a) allowing an air stream to pass through said panel (21) and enter said housing; said holes (212a) are cut exclusively in said protrusions (212) so that
at least said substrate (1b) at said protrusions (212) is traversed by said airflow; and
said substrate (1b) in correspondence with said depressions (211) is not traversed by said airflow ensuring the permanence of a humidity in said substrate (1b) contained in at least said depressions (211) and thus the definition in said substrate of a biofilm which, coming into contact with said airflow, purifies said airflow.

2. Purification device (1) according to claim 1, wherein said panel (21) defines the bottom of said housing so as to allow said substrate (1b) to rest by gravity on said panel (21).

3. Purification device (1) according to claim 1, wherein said holes (212a) have a cross-sectional area of less than 10 mm².

4. Purification device (1) according to claim 1, wherein said holes (212a) have a cross-sectional area inversely proportional to the distance from the apex of said protrusions (212).

5. Purification device (1) according to claim 1, wherein said panel (21) has a thickness substantially constant and substantially between 3 mm and 5 mm.

6. Purification device (1) according to claim 1, comprising an irrigation block (61) configured to supply water to said substrate (1b), and a control system (7) comprising a board (71) for controlling said purification device (1) and a humidity sensor (72) configured to detect the humidity of said substrate (1b) at least at said depressions (211) so as to enable said board (71) to control said irrigation block (61) according to said humidity of said substrate (1b).

7. Purification device (1) according to claim 1, comprising a structure (4) defining a substantially sealed culture chamber, an inlet section (1d) of air into said culture chamber and an outlet section (1e) of said air from said culture chamber; wherein said container (2) being placed in said culture chamber so that said panel (21) is downstream of said inlet section (1d) with respect to the direction of advancement of said air.
